(19) United States
(12) Patent Application Publication
(10) Pub. No.: US 2011/0056383 A1
(43) Pub. Date: Mar. 10, 2011

(54) FILTER

(76) Inventors: Charlotte Make, Spital/Drau (AT); Martin Make, Spital/Drau (AT); Walter Make, Spital/Drau (AT)

(21) Appl. No.: 12/919,230

(22) PCT Filed: Feb. 25, 2009
(86) PCT No.: PCT/AT09/00076

§ 371 Date: Nov. 2, 2010

(30) Foreign Application Priority Data
Feb. 25, 2008 (AT) A 310/2008
Oct. 6, 2008 (EP) 08450151.9

(51) Int. Cl. B01D 46/42; B01D 46/00

(52) U.S. Cl. 96/396; 55/419; 55/385.3

(57) ABSTRACT

A filter (50) that can be located on vehicles in the region of the relative wind has an inlet-side perforated sheet with slanted guide surfaces (5, 7), a preliminary filter (9), a coarse dust filter (23), a first fine dust filter (27) with a free space (25) between the coarse dust filter (23) and the fine dust filter (27), a second fine dust filter (31) with a free space (29) between the fine dust filters (27, 31) and, on the air exit side, another perforated sheet (33) with slanted guide surfaces (35). With this filter, when vehicles, especially motor vehicles, are traveling on roads, there is effective filtering of dust, especially also fine dust, from the air that is flowing through the filter (50) under the action of the relative wind.

The invention relates to a filter with the features of the introductory part of Claim 1. The object of the invention is to devise a filter that can be located on vehicles and that, especially while the vehicle is moving, is able to effectively filter dust, especially fine dust, from the air.

This object is achieved according to the invention with a filter that has the features of Claim

Preferred and advantageous configurations of the filter according to the invention are the subject matter of the dependent claims.

Since the filter according to the invention ensures not only several filter layers, but also effective protection against the entry of water into the filter, it is easily possible, and especially without adversely affecting the efficiency and operation of the filter, to mount it on vehicles.

All vehicles can be considered, regardless of whether they are ground vehicles, such as road vehicles and rail cars, aircraft or watercraft.

It is preferable if the filter according to the invention is located on the front surface or in the region of the front surface of a vehicle.

Within the framework of the invention, it is also possible to supply the air flow that is used to cool the drive motor to the input side of the filter according to the invention before or after passage through the radiator of the drive motor.

The arrangement of the filter according to the invention above the front window or windshield of vehicles is quite especially preferred. In this arrangement, the entry-side boundary wall of the filter that therefore points forward can be arranged slanted in the manner of a spoiler.

Installation of the filter on the bottom of a vehicle, e.g., with the entry opening lying in the region of the bumper, is also considered.

Since, in the filter according to the invention, there are boundary walls on its front and its rear (the end surface of the filter pointing forward relative to the direction of travel and the end surface of the filter pointing backward relative to the direction of travel), which walls are made and set up to allow the entry or exit of air, but also to prevent the entry of water into the filter as far as the filter layers, the effective result is that the filter layers of the filter do not become wet and their filter action, especially when fine dust is being filtered out, is not adversely affected.

In one preferred embodiment of the filter according to the invention, between the filter layers of the internals, there are free spaces that make it possible for dust that has passed through the filter layers anyway to collect and settle there, optionally with the formation of a fine dust cake, and if the dust was moist, it is dried there so that filtering is enhanced.

The perforated walls on the end surfaces of the filter that prevent the entry of water are, for example, rib meshes with parts that are aligned obliquely to their surface extension and/or perforated sheets with guide surfaces that are attached to them, especially pointing to the inside, and that are tilted to the surface extension of the wall.

In one possible embodiment that is considered within the framework of the invention, the filter according to the invention is characterized in that the entry-side boundary wall, e.g., a perforated plate or rib mesh, bears slanted guide surfaces on its side facing the interior of the filter.

In one possible embodiment that is considered within the framework of the invention, the filter according to the invention is characterized in that there are guide surfaces with different lengths, specifically shorter guide surfaces and longer guide surfaces.

In one possible embodiment that is considered within the framework of the invention, the filter according to the invention is characterized in that the guide surfaces are aligned rising obliquely upward relative to the direction of air flow through the filter.

In one possible embodiment that is considered within the framework of the invention, the filter according to the invention is characterized in that there is a wall with holes and guide surfaces, e.g., a perforated plate, following the preliminary filter.

In one possible embodiment that is considered within the framework of the invention, the filter according to the invention is characterized in that the guide surfaces are aligned pointing obliquely downward relative to the direction of air flow through the filter.

In one possible embodiment that is considered within the framework of the invention, the filter according to the invention is characterized in that upstream from the first filter layer, there is a carrier with flaps that are pivotally mounted on it.

In one possible embodiment that is considered within the framework of the invention, the filter according to the invention is characterized in that between the carrier and the wall, downstream from the preliminary filter there is a channel for draining the water that has entered the filter.

In one possible embodiment that is considered within the framework of the invention, the filter according to the invention is characterized in that a moisture sensor is assigned to the channel.

In one possible embodiment that is considered within the framework of the invention, the filter according to the invention is characterized in that the flaps on the carrier are controlled in their action by the moisture filter such that the flaps are closed when the moisture sensor detects moisture in the channel.

In one possible embodiment that is considered within the framework of the invention, the filter according to the invention is characterized in that the preliminary filter is a washable organic or mineral fiber.

In one possible embodiment that is considered within the framework of the invention, the filter according to the invention is characterized in that the filter layer that is located preferably following the flaps is a coarse dust filter.

In one possible embodiment that is considered within the framework of the invention, the filter according to the invention is characterized in that there are two fine dust filters in succession.

In one possible embodiment that is considered within the framework of the invention, the filter according to the invention is characterized in that there is a free space between the first fine dust filter and the coarse dust filter.

In one possible embodiment that is considered within the framework of the invention, the filter according to the invention is characterized in that there is a free space between the fine dust filters.

In one possible embodiment that is considered within the framework of the invention, the filter according to the invention is characterized in that there are guide surfaces projecting to the outside from the outflow-side boundary wall.

In one possible embodiment that is considered within the framework of the invention, the filter according to the invention is characterized in that the guide surfaces of the outflow-side boundary wall, e.g., of the perforated sheet, are aligned descending obliquely downward relative to the flow direction of the air through the filter.

In one possible embodiment that is considered within the framework of the invention, the filter according to the invention is characterized in that the free ends of the guide surfaces are angled downward on the outflow-side perforated sheet.

In one possible embodiment that is considered within the framework of the invention, the filter according to the invention is characterized in that the individual components of the filter are self-supporting components that are inserted and can be removed individually in a housing.

In one possible embodiment that is considered within the framework of the invention, the filter according to the invention is characterized in that the first fine dust filter is a filter of class F5.

In one possible embodiment that is considered within the framework of the invention, the filter according to the invention is characterized in that the second fine dust filter is a filter of class F6.

In one possible embodiment that is considered within the framework of the invention, the filter according to the invention is characterized in that there is a free space between the fine dust filter and the boundary wall that is located on the exit side.

The invention also relates to a vehicle with the features of Claim 15, the entry-side boundary wall of the filter being located in the region of an air flow that forms when the vehicle is moving.

In one possible embodiment that is considered within the framework of the invention, the vehicle according to the invention is characterized in that the entry-side boundary wall of the filter is aligned essentially perpendicular to the lengthwise extension of the vehicle.

In one possible embodiment that is considered within the framework of the invention, the vehicle according to the invention is characterized in that the filter with its entry-side boundary wall is located above the passenger compartment of a vehicle, especially in the region above the windshield. Arrangements of the filter laterally next to or under the passenger compartment are likewise considered within the framework of the invention.

In one possible embodiment that is considered within the framework of the invention, the vehicle according to the invention is characterized in that in trucks, the filter is located aligned rising obliquely upward from the top edge of the windshield.

In one possible embodiment that is considered within the framework of the invention, the vehicle according to the invention is characterized in that the entry-side boundary wall is aligned obliquely to the lengthwise extension of the vehicle.

Other details, features and advantages of the filter according to the invention and its use on vehicles will become apparent using the following description of one preferred embodiment.

Here:

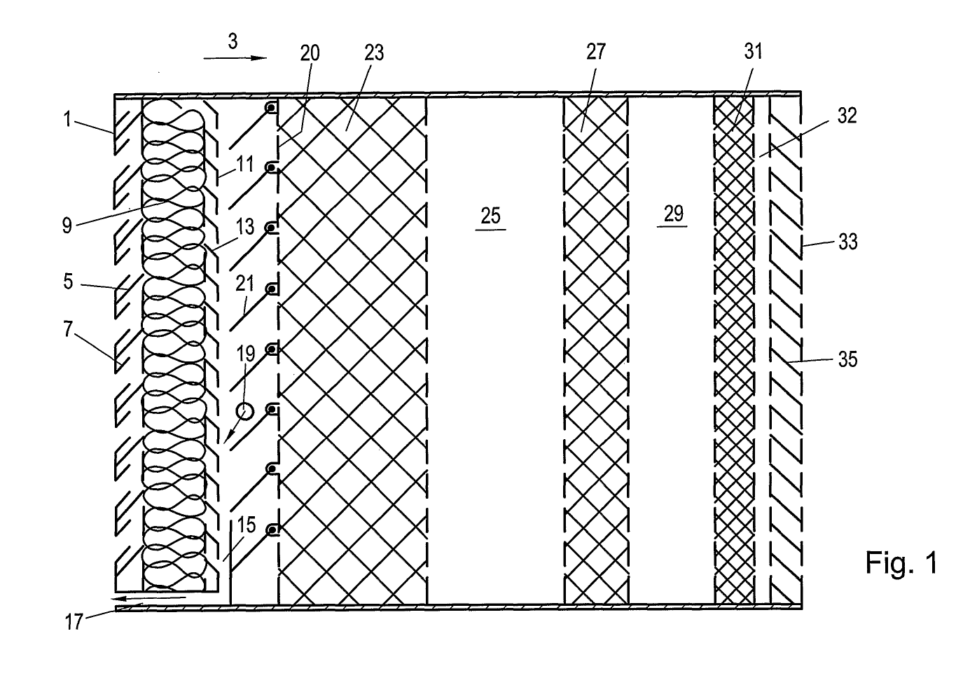

FIG. 1 schematically shows the fundamental structure of a filter in one example,

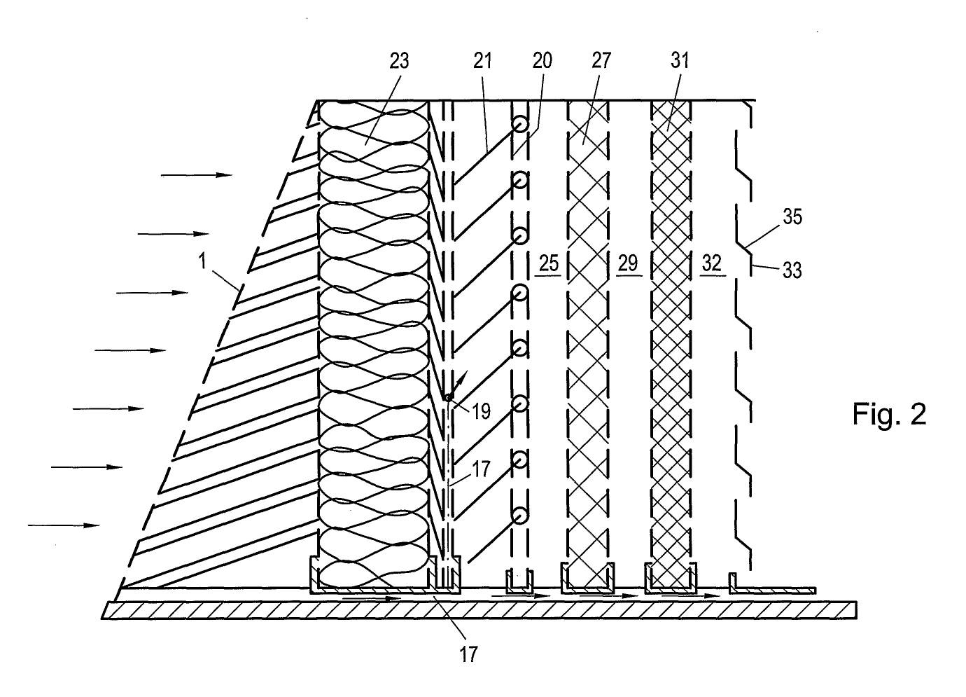

FIG. 2 shows a modified embodiment,

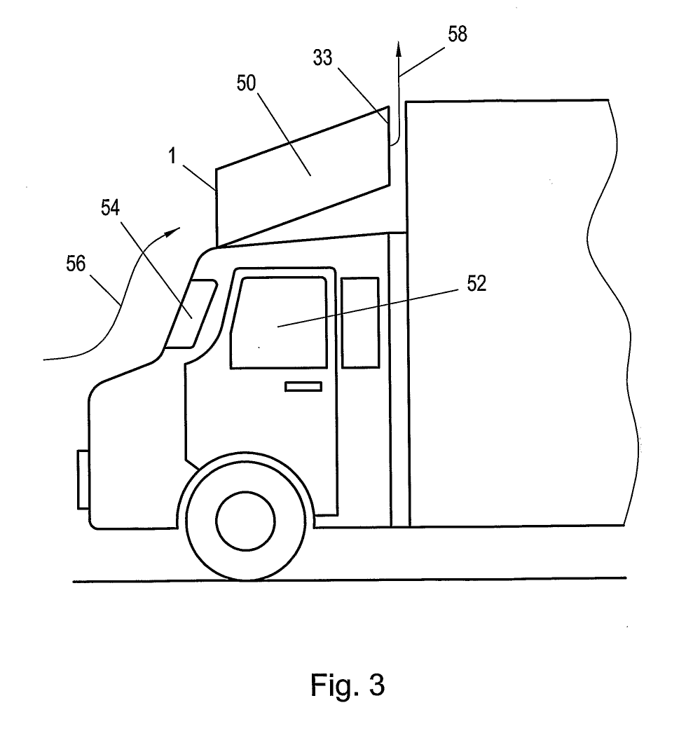

FIG. 3 schematically shows a first installation example of a filter according to the invention,

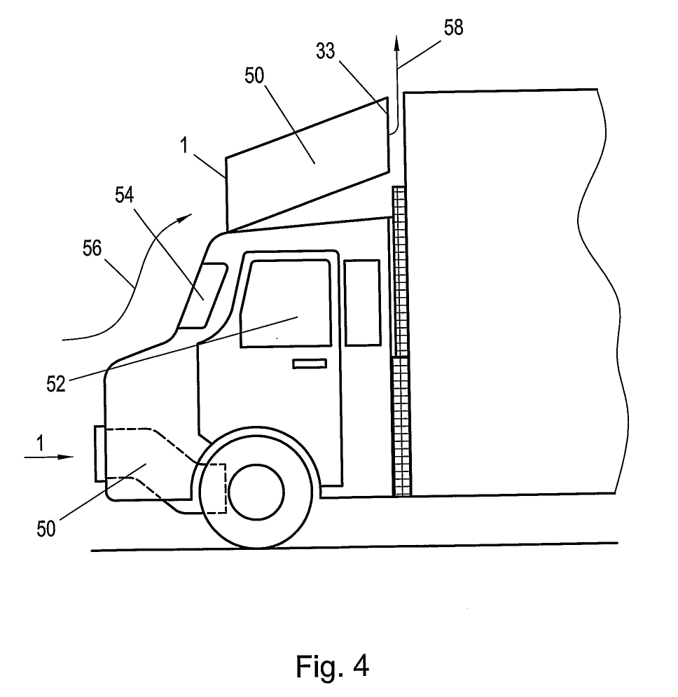

FIG. 4 schematically shows another installation example of the filter according to the invention, and

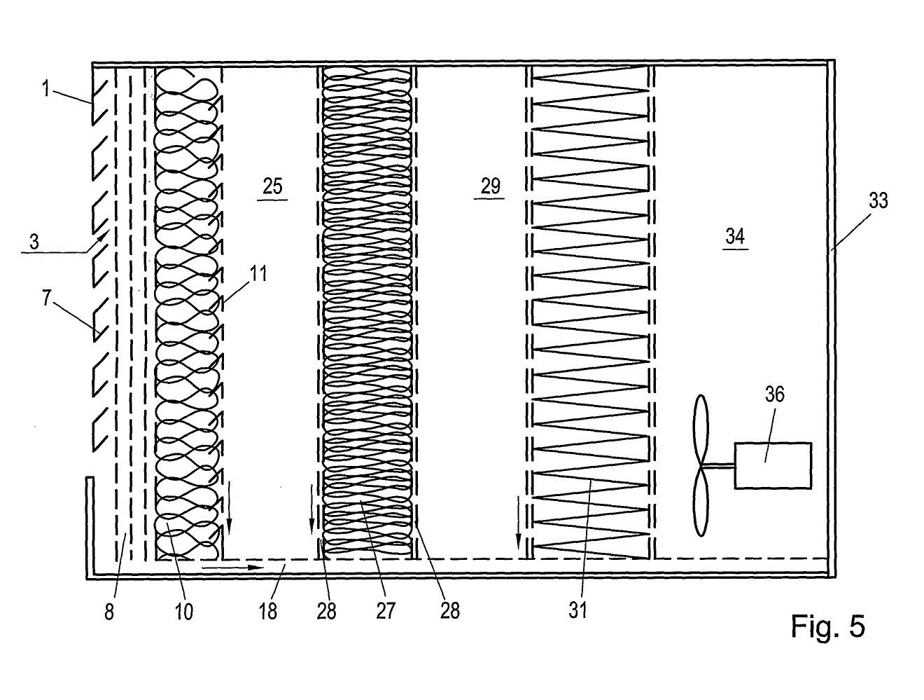

FIG. 5 schematically shows another embodiment of a filter according to the invention.

In the embodiment shown in FIG. 1, the filter according to the invention has the structure described below. The individual parts of the filter are mentioned and described in the sequence, which corresponds to the direction of flow of the air to be filtered through the filter:

On the entry side, the wall that forms the end surface is a perforated sheet 1 or a rib mesh, consisting of a material that is resistant to corrosive rain, salt water, etc. On the inside of the perforated sheet 1 in the flow direction of the air (arrow 3), there are guide surfaces 5, 7 that point obliquely upward. There are longer guide surfaces 5 and shorter guide surfaces 7 here. When the filter is located above the windshield of a vehicle, the front boundary wall can be tilted in the manner of a “spoiler,” as is shown in FIG. 2.

The guide surfaces 5, 7 route the air flow into a first preliminary filter 9. The preliminary filter 9 consists of a washable filter material, especially a filter material that consists of plastic or mineral substance in fiber form. Here, water entering through the entry-side perforated sheet 1 can be used to clean the preliminary filter 9 by washing it out.

The guide surfaces 5, 7 on the inside of the perforated sheet 1 improve drying of the preliminary filter 9 after it has been washed out.

Following the preliminary filter 9, on its inside, there is another perforated sheet 11 with guide surfaces 13 or a rib mesh, the guide surfaces 13 viewed in the flow direction (arrow 9) being aligned running obliquely downward, therefore opposite the slanted position of the guide surfaces 5 and 7. In this way, water that is passing through the preliminary filter 9 is diverted downward and emerges again through an angled lower channel 15 along the bottom of the filter housing on the bottom end 17 out of the filter arrangement forward (FIG. 1) or preferably to the rear (FIG. 2). Thus, it is ensured that water cannot travel into the components of the filter according to the invention that are formed following the arrangement consisting of the perforated sheet 1, preliminary filter 9 and perforated sheet 11. In the region of the channel 15, there is a rain sensor 19 (moisture sensor) that controls flaps 21 that are arranged downstream from the second perforated sheet 11 and that closes them when an especially large amount of water passes through the preliminary filter 9, e.g., when driving through a car wash. These flaps 21 are closed by a motor in the case of starting so that water cannot penetrate further into the interior of the filter.

There is a coarse dust filter 23 downstream from the arrangement with the flaps 21. The coarse dust filter 23 consists of the same material as the first preliminary filter 9, but is preferably made denser (smaller free passage cross-sectional area) than the preliminary filter 9.

Following the coarse dust filter 23, there is a free space 25 in which dust, especially fine dust, can settle.

Following the free space 25, there is a first fine dust filter 27. This fine dust filter 27 filters fine dust with an order of magnitude of roughly 10 μm from the air that is flowing through the filter. The fine dust filter 27 can be a filter (F5, DIN 779) that contains a filter pack of folded (pleated) microfiber paper with plastic spacer filaments (fold pack). For example, a filter from Euro Filter GmbH (Dortmund, FRG) of filter class EN 1822 and of design/type H13 or H14 is suitable.

Following the fine dust filter 27, there is another free space 29. In the free spaces 25 and 29, not only is settling of (fine) dust particles possible, but the (fine) dust particles are dried.

Following the second free space 29, there is another fine dust filter 31 for filtering fine dust particles with a size of less than, for example, 1 μm. This fine dust filter 31 can be a filter of filter class F6 from Euro Filter GmbH (Dortmund, FRG).

The filter layers of the fine dust filter can be located between support gratings.

There is another free space 32 downstream from the fine dust filter 31.

Following the free space 32 downstream from the second fine dust filter 31, there is a wall that forms the back end surface and that, for example, is a perforated sheet 33 similar to the perforated sheet 11 downstream from the first preliminary filter 9 with guide surfaces 35 that are slanted downward to the rear. This prevents entry of rain water from the back of the filter.

In the perforated sheet 33 with guide surfaces 35, the guide surfaces 35 are made larger and are optionally angled downward in order to ensure that water cannot enter the filter from the rear.

The indicated components (perforated sheet 1, preliminary filter 9, perforated sheet 11, carrier 20 for the flaps 21, (coarse dust) filter 23, (fine dust) filter 27, (fine dust) filter 31 and perforated sheet 33 are preferably self-supporting components (“cassettes”) that can be inserted into a housing that surrounds the filter. Thus, it is possible to replace individual parts of the filter.

The filter according to the invention is especially designed to be mounted on vehicles on their front, especially in the region above the windshield. The filter according to the invention can be integrated above the passenger compartment of a vehicle, especially a truck, for example into a spoiler provided there. In this case, above the entry opening into the filter, headlights or blinkers can be additionally mounted.

It is possible to arrange the entry opening of the filter in the region above the front bumper of a vehicle.

All locations on vehicles in which a relative wind is acting are conceivable here. One installation example is shown by FIG. 3. In this example, a filter 50 of the invention that, for example, has the structure described using FIG. 1 or FIG. 2 is mounted above the passenger compartment 52, therefore above the windshield 54, so that the relative wind (arrow 56) enters the filter 50 via the perforated sheet 1 and emerges again from the filter 50 with the dust removed through the perforated sheet 33 (arrow 58).

The installation example from FIG. 4 shows how a filter according to the invention can also be arranged in the region of the bottom of a vehicle such that the entry-side front wall (perforated sheet 1) is located in the region of the front bumper.

The embodiment of a filter according to the invention that is shown in FIG. 5 has the structure described below.

On the entry side, the wall that forms an end surface is a perforated sheet 1 or a rib mesh that consists of a material that is resistant to corrosive rain, salt water, etc. On the inside of the perforated sheet 1 in the flow direction of the air (arrow 3), there are guide surfaces 7 that point obliquely upward.

When the filter is located above the windshield of a vehicle, the front boundary wall can be slanted in the manner of a spoiler, as is shown in, for example, FIG. 2.

The guide surfaces 7 route the air flow to a layer of metal nonwoven floss, especially steel nonwoven floss 8, water that collects in the space between the perforated sheet 1 and the layer 8 of steel nonwoven floss flowing downward to a channel 18 that is provided in the lower boundary wall of the filter. Water entering the channel 18 flows to the filter end that is the back end relative to the direction of travel (to the right in FIG. 5).

Following the layer 8 of steel nonwoven floss, there is a layer 10 that is used as a coarse dust filter and that is formed from a waterproof filter material. Water arising in the coarse dust filter 10 also flows downward into the channel 18.

There is again a rib mesh 11 similar to the rib mesh 1 on the side (back side) of the layer 10 that is used as the coarse dust filter, which side is facing away relative to the flow direction (arrow 3). Following the rib mesh 11, there is a free space 25 that adjoins, always relative to the flow direction, a first fine dust filter 27 that is located between the support gratings 28 and likewise consists of waterproof filter material. Downstream from the fine dust filter 27, there is another free space 29 followed by a second fine dust filter 31 that is inserted in a frame.

At a distance from the fine dust filter 31, there is another free space 34 and then a back wall 33 in the form of a perforated sheet, for example similar to the perforated sheet 11, or in the form of a support grating as the wall that forms the back end surface of the filter. In the space 34, in one embodiment there can be at least one motorized fan 36 that also produces the air flow necessary for the effectiveness of the filter, when the vehicle in which the filter is installed is stopped or only driving slowly.

In summary, one embodiment of the invention can be described as follows: A filter 50 that can be located on vehicles in the region of the relative wind has an inlet-side perforated sheet with slanted guide surfaces 5, 7, a preliminary filter 9, a coarse dust filter 23, a first fine dust filter 27 with a free space 25 between the coarse dust filter 23 and the fine dust filter 27, a second fine dust filter 31 with a free space 29 between the fine dust filters 27, 31, and, on the air exit side, another perforated sheet 33 with slanted guide surfaces 35. With this filter, when vehicles, especially motor vehicles, are traveling on roads, there is effective filtering of dust, especially also fine dust, from the air that is flowing under the action of the relative wind through the filter 50.

1. Filter for removing dust, especially fine dust, from the air, characterized by a boundary wall (1) that is provided with openings and that is located on the entry side, a preliminary filter (9), a first filter layer (23), at least one free space (25, 29), a second filter layer (27), and, on the exit side, a rear boundary wall (33).

2. Filter according to claim 1, wherein the entry-side boundary wall, e.g., a perforated plate (1), on its side facing the interior of the filter (50), bears slanted guide surfaces (5, 7).

3. Filter according to claim 2, wherein there are guide surfaces with different lengths, specifically shorter guide surfaces (7) and longer guide surfaces (5).

4. Filter according to claim 2, wherein the guide surfaces (5, 7) are aligned rising obliquely upward relative to the direction of flow (arrow 3) of air through the filter (50).

5. Filter according to claim 1, wherein there is a wall (11) with holes and guide surfaces (13), e.g., a perforated plate, following the preliminary filter (9).

6. Filter according to claim 5, wherein the guide surfaces (13) are aligned pointing obliquely downward relative to the direction (arrow 3) of air flow through the filter (50).

7. Filter according to claim 1, wherein upstream from the first filter layer (23), there is a carrier (20) with flaps (21) that are pivotally mounted on it.

8. Filter according to claim 7, wherein between the carrier (20) and the wall (11) downstream from the preliminary filter (9), there is a channel (15) for draining the water that has entered the filter (50).

9. Filter according to claim 8, wherein a moisture sensor (19) is assigned to the channel (15).

10. Filter according to claim 9, wherein the flaps (21) on the carrier (20) are controlled in their action by the moisture filter (19) such that the flaps (21) are closed when the moisture sensor (19) detects moisture in the channel (15).

11. Filter according to claim 1, wherein the preliminary filter (9) is a washable organic or mineral fiber.

12. Filter according to claim 1, wherein the filter layer (23) that is located preferably following the flaps (21) is a coarse dust filter.

13. Filter according to claim 1, wherein there are two fine dust filters (27, 31) in succession.

14. Filter according to claim 1, wherein there is a free space (25) between the first fine dust filter (27) and the coarse dust filter (23), and wherein there is a free space (29), optionally also between the fine dust filters (27, 31).

15. Vehicle with a filter (50) according to claim 1, wherein the entry-side boundary wall (1) of the filter (50) is located in the region of an air flow (56) that forms when the vehicle is moving.

16. Filter according to claim 3, wherein the guide surfaces (5, 7) are aligned rising obliquely upward relative to the direction of flow (arrow 3) of air through the filter (50).
